(19) United States
(12) Patent Application Publication
(10) Pub. No.: US 2024/0386195 A1
(43) Pub. Date: Nov. 21, 2024

(54) TABLE PROCESSING METHOD, APPARATUS, DEVICE, STORAGE MEDIUM AND PROGRAM PRODUCT

(71) Applicant: Beijing Zitiao Network Technology Co., Ltd., Beijing (CN)

(72) Inventors: Kailin XU, Beijing (CN); Mingtao LUO, Beijing (CN)

(21) Appl. No.: 18/665,148

(22) Filed: May 15, 2024

(30) Foreign Application Priority Data
May 15, 2023 (CN) 202310542741.1

(51) Int. Cl. G06F 40/177

(52) U.S. Cl. CPC G06F 40/177

(57) ABSTRACT

Embodiments of the present application relate to a table processing method, apparatus, device, storage medium and program product. The method comprises: in response to creating a target formula in an online table, determining a target formula key corresponding to the target formula; and creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula. Some instance attributes comprised in the formula instance created in the embodiments of the present disclosure reference storage objects, thereby reducing the occupation of the memory space.

### CROSS-REFERENCE TO RELATED APPLICATION(S)

This application claims priority to Chinese Application No. 202310542741.1 filed on May. 15, 2023, the disclosures of which are incorporated herein by reference in its entity.

### FIELD

The present application relates to the technical field of computer processing, and in particular, to a table processing method, apparatus, device, storage medium and program product.

### BACKGROUND

Each formula in an online table creates a corresponding formula instance in memory, and the formula instance is used to calculate the formula.

### SUMMARY

In a first aspect, the embodiments of the present disclosure provide a method of table processing, comprising:

in response to creating a target formula in an online table, determining a target formula key corresponding to the target formula; and

creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

In a second aspect, the embodiments of the present disclosure provide an apparatus of table processing, comprising:

a target formula key determining module configured to, in response to creating a target formula in an online table, determine a target formula key corresponding to the target formula; and

a formula instance creating module configured to create a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

In a third aspect, the embodiments of the present disclosure provide an electronic device, comprising:

one or more processors;

a storage unit configured to store one or more programs,

the one or more programs, when executed by the one or more processors, causing the one or more processors to implement the table processing method as described in the first aspect.

In a fourth aspect, the embodiments of the present disclosure provide a computer readable storage medium, storing a computer program thereon, wherein the computer program, when executed by a processor, implements the table processing method as described in the first aspect.

In a fifth aspect, the embodiments of the present disclosure provide a computer program product, comprising a computer program or instructions which, when executed by a processor, implement the table processing method as described in the first aspect.

The embodiments of the present disclosure provide a method, apparatus, device, storage medium and program product of table processing. The method comprises: in response to creating a target formula in an online table, determining a target formula key corresponding to the target formula; and creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula. Some instance attributes comprised in the formula instance created in the embodiments of the present disclosure reference storage objects, thereby reducing the occupation of the memory space.

### BRIEF DESCRIPTION OF THE DRAWINGS

Through the following specific implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 shows an architectural diagram of a table processing scenario provided by the embodiments of the present disclosure;

FIG. 2 shows a schematic flowchart of a table processing method in the embodiments of the present application;

FIG. 3 shows a schematic diagram of references by formula symbol sequences in the embodiments of the present disclosure;

FIG. 4 shows a schematic diagram of intermediate representations (IRs) of different formulas in the embodiments of the present disclosure;

FIG. 5 shows a schematic diagram of references to IRs in the embodiments of the present disclosure;

FIG. 6 shows a schematic diagram of the process for IR generating in the embodiments of the present disclosure;

FIG. 7 shows a structural schematic diagram of a table processing apparatus in the embodiments of the present disclosure; and

FIG. 8 shows a structural schematic diagram of an electronic device in the embodiments of the present application.

### DETAILED DESCRIPTION OF EMBODIMENTS

The embodiments of the present application will be described with reference to the accompanying drawings, in which some embodiments of the present application have been illustrated. However, it should be understood that the present application can be implemented in various manners, and thus should not be construed to be limited to embodiments disclosed herein. On the contrary, those embodiments are provided for the thorough and complete understanding of the present application. It should be understood that the drawings and embodiments of the present application are only used for illustration, rather than limiting the protection scope of the present application.

It should be understood that various steps described in method implementations of the present application may be performed in a different order and/or in parallel. In addition, the method implementations may comprise an additional step and/or omit a step which is shown. The scope of the present application is not limited in this regard.

The term “comprise” and its variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present application are only for differentiating different apparatuses, modules or units rather than limiting the order or mutual dependency of functions performed by these apparatuses, modules or units.

Note that the modifications “one” and “a plurality” mentioned in the present application are illustrative rather than limiting, and those skilled in the art should understand that unless otherwise specified, they should be understood as “one or more.”

Names of messages or information interacted between a plurality of apparatuses in the implementations of the present application are merely for the illustration purpose, rather than limiting the scope of these messages or information.

Before describing the embodiments of the present disclosure in further detail, the terms and terminology involved in the embodiments of the present disclosure are explained, which are subject to the following interpretations.

“In response to” is used to indicate a condition or state on which an operation performed relies. When the condition or state is satisfied, the one or more operations performed may be in real time or have a set delay; there is no restriction on the order of execution of the plurality of operations performed, unless specifically stated otherwise.

It is to be understood that, before applying the technical solutions disclosed in various embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, and prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As described in the BACKGROUND, formulas are often used for calculation in usage scenarios of online tables. For example, a numerical value in cell A1 plus 1 equals a numerical value in cell A2, in which a formula used is A2=A1+1. Each formula in an online table creates a corresponding formula instance in memory, and the formula instance is used to calculate the formula. As the number of formulas in the online table gets large, formula instances in memory increase as well, and the online table is more prone to webpage crashes due to out of memory.

By observing data on user tables, it can be found that in an online form containing a large number of formulas, many of the formulas are obtained by copying a particular formula. For example, in order to calculate the same type of data in a batch, users usually copy and paste or drop down to fill some formula that has already been written. Such formulas share many of the same features.

As the number of formulas in the online table gets large, formula instances in memory increase as well, and the online table is more prone to webpage crashes due to out of memory. To solve the above technical problems, the embodiments of the present disclosure provide a table processing method, apparatus, device, storage medium and program product, which can reference some instance attributes in a formula and reduce the occupation of memory space.

In view of this, the embodiments of the present disclosure provide a table processing method, apparatus, device, storage medium and program product. The method comprises: in response to creating a target formula in an online table, determining a target formula key corresponding to the target formula; creating a formula instance based on the target formula, wherein a target instance attribute comprised in the formula instance references a target storage object in a pre-created object reference pool, the object reference pool comprises correspondence relationships between formula keys and storage objects, the target storage object is a storage object having a correspondence relationship with the target formula key, and the formula instance is for calculating the target formula. Some instance attributes comprised in the formula instance created in the embodiments of the present disclosure reference storage objects, thereby reducing the occupation of memory space.

The table processing method provided in the embodiments of the present disclosure will be explained in detail with reference to the accompanying drawings.

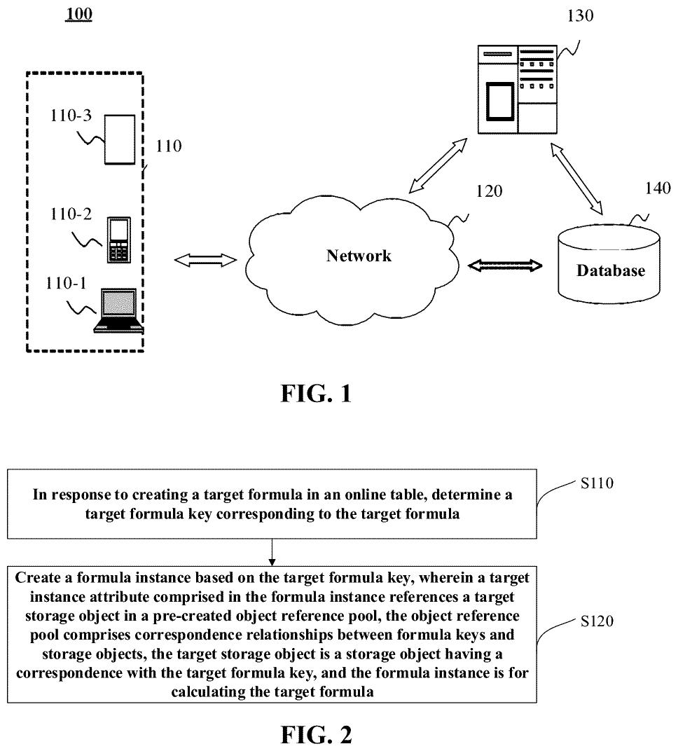

FIG. 1 is a system that can be used to implement table processing provided in the embodiments of the present disclosure. As shown in FIG. 1, the system 100 may comprise a plurality of user terminals 110, a network 120, a server 130 and a database 140. For example, the user terminal 110 may be used to implement the table processing method as described in any of the embodiments of the present disclosure.

It is to be understood that the user terminal 110 may be any other type of electronic device capable of performing data processing, which may include, without limitation to, a mobile phone, a station, a unit, a device, a multimedia computer, a multimedia tablet, an internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/video camera, a locator device, a television receiver, a radio broadcast receiver, an e-book device, a gaming device, or any combination thereof, including accessories and peripherals for such devices or any combination thereof.

The embodiments of the present disclosure have no limitation on the hardware system as well as the software system of the user terminal 110. For example, the user terminal 110 may be based on a processor such as ARM, X86, etc., may have an input/output device such as a camera, a touch screen, a microphone, etc., and may have such an operating system as Windows, iOS, Linux, Android and Harmony OS running thereon.

The user terminal 110 may implement the table processing method provided by the embodiments of the present disclosure by running a process or thread. In some examples, the user terminal 110 may perform the table processing method by using a built-in application program. In other examples, the user terminal 110 may perform the table processing method by invoking an application program stored externally to the user terminal 110.

The network 120 may be a single network or a combination of at least two different networks. For example, the network 120 may include, without limitation to, one or a combination of a local area network, a wide area network, a public network, a private network and the like. The network 120 may be a computer network such as the Internet and/or various telecommunication networks (e.g., 3G/4G/5G mobile communication networks, WIFI, Bluetooth, ZigBee, etc.), and the embodiments of the present disclosure are not intended to limit in this regard.

The server 130 may be a single server, a cluster of servers, or a cloud server, with individual servers within the cluster being connected via a wired or wireless network. A cluster of servers may be centralized, such as a data center, or distributed. The server 130 may be local or remote, and may communicate with the user terminal 110 over a wired or wireless network. The embodiments of the present disclosure are not intended to limit the hardware system and software system of the server 130.

The database 140 may refer generally to a device having a storage function. The database 140 is mainly used to store various data utilized, generated and output by the user terminal 110 and the server 130 in the course of their work. The database 140 may be local or remote, and may include various types of memory, such as random access memory (RAM), read only memory (ROM), etc. The storage devices mentioned above are only examples enumerated, and storage devices that may be used by the system 100 are not limited thereto. The embodiments of the present disclosure are not intended to limit the hardware system and software system of the database, which may be, for example a relational database or a non-relational database.

The database 140 may be interconnected or communicate with the server 130 or a portion thereof via the network 120, or directly interconnected or communicate with the server 130, or a combination of the above.

In some example, the database 140 may be a stand-alone device. In other examples, the database 140 may also be integrated in at least one of the user terminal 110 and the server 130. For example, the database 140 may be configured on the user terminal 110 or on the server 130. As another example, the database 140 may also be distributed, with a portion configured on the user terminal 110 and another portion configured on the server 130.

FIG. 2 is a flowchart of a table processing method in the embodiments of the present disclosure. This embodiment is applicable to the optimization of formula instances in online tables. The method may be performed by a table processing apparatus, which may be implemented in software and/or hardware and may be configured in the electronic device as described in FIG. 1.

As shown in FIG. 2, the table processing method provided by the embodiments of the present disclosure comprises S110-S120.

S110, in response to creating a target formula in an online table, determining a target formula key corresponding to the target formula.

In the embodiments of the present disclosure, the online table is a table for online editing by users, multi-user collaboration and stored in the cloud in real time, which relies on communication between the terminal and the server to synchronize user's editions.

In some embodiments, the online table is displayed through a client installed on the terminal, which in practice may be a social client such as an IM client. The client is integrated with the function of online tables. Based on the user's click operation, the client loads a page of the online table by invoking a browser kernel through an interface provided by the browser, and then the user can create and edit the online table based on the loaded page. The user may realize the sharing of the online table through the client. In other embodiments, the client is integrated with the browser kernel, and the page of the online table can be displayed on the client by invoking the browser kernel. In other embodiments, the client is an online table client, and the page of the online table can be loaded by running the online table client. In other embodiments, there exists an applet for the online table function, and the client can load the page of the online table by downloading and running the source code of the online table applet.

When the user creates an online table or opens a created online table by the above mentioned implementation, he/she can, data editing processing may be performed on the page of the online table displayed at the terminal according to personal needs, such as inputting new data into a cell, modifying or deleting the data already stored in a cell, performing data calculations with formulas, and so on.

In one implementation of the present disclosure, the target formula may be construed as a formula currently created by the user in the online table for data calculation.

In one possible implementation of the present disclosure, the response to creating a target formula in an online table comprises: in response to a selection operation of the user against a preset function in the online table, determining an operation type of the formula; in response to a numerical value entered by the user to the online table, determining the target formula based on the numerical value and the operation type, wherein the numerical value entered to the online table may be a specific numerical value entered by the user or referencing a numerical value in one or more cells in the online table selected by the user.

In the embodiments of the present disclosure, the online table comprises a plurality of cells, with rows of cells denoted by letters and columns of cells denoted by numbers. A cell corresponds to a unique cell identification, which may be expressed in the form of letter +number. For example, cell identification A1 represents a cell corresponding to the first row of column A.

In one implementation of the present disclosure, the response to creating a target formula in an online table comprises: in response to a numerical value entered by the user to the online table, determining a numerical value to be calculated; in response to a selection operation of the user against a preset function in the online table, determining an operation type of the formula; and determining the target formula based on the numerical value to be calculated and the operation type, wherein the numerical value entered to the online table may be a specific numerical value entered by the user or may be a numerical value in one or more cells in the online table selected by the user.

In the embodiments of the present disclosure, the formula key may be construed as a key value determined based on the formula, by which a corresponding value may be accessed, the value being a storage object. In the same online table, the same formulas may correspond to a formula key. The same formula can be understood as both the same operation type in the formula and the same parameter for performing the operation, wherein the parameters being the same may be construed as the parameter type at the same position in the formula being the same, and the specific numerical value of constants being the same when the parameter type is a constant. For example, in an addition formula, the left side of the plus sign is a referenced cell, the right side of the plus sign is a constant, and constants have the same numerical values. For example, the formulas A1+2 and B1+2 may be construed as the same formulas.

In the embodiments of the present disclosure, the target formula key corresponding to the target formula is obtained after processing the target formula based on a preset processing rule.

In one implementation of the present disclosure, a formula symbol sequence tokens corresponding to the target formula is obtained by processing the target formula, and the formula symbol sequence is combined into a string as the target formula key. The formula symbol sequence is used to uniquely describe a formula from left to right, mainly to record constants and references in formula text. For example, the formula symbol sequence of the formula A1+1 is [‘R1’,‘C+1’], wherein [R1] describes that the first numerical value in the formula is the first reference table;

[C+1] is used to describe that the constant content is “+1”; [‘R1’,‘C+1’] is combined into a string R1C+1, i.e., R1C+1 is the formula key of the formula A1+1.

S120, creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence relationship with the target formula key, and the formula instance is for calculating the target formula.

In one implementation of the present disclosure, the formula instance comprises a plurality of instance attributes, and the target instance attribute refers to an instance attribute that can be realized by reference.

In one implementation of the present disclosure, an object reference pool is pre-designed to save the same storage objects. A data storage structure in the object reference pool is as shown in Table 1 below, in which each formula key corresponds to a unique storage object. In this way, it can be ensured that there is only one same formula instance attribute in the memory. The storage object may be a formula symbol sequence and/or formula compilation intermediate code.

TABLE 1

| Formula Key | Storage Object |
|---|---|
| Formula key 1 | Storage object 1 |
| Formula key 2 | Storage object 2 |

In the embodiments of the present disclosure, during the process of creating the formula instance corresponding to the target formula, the object reference pool is queried based on the target formula key, and if a storage object corresponding to the target formula key can be found, the storage object will be directly referenced as an instance attribute, and the instance attribute will no longer be created, so as to reduce the occupation of memory space.

In one implementation of the present disclosure, if the target storage object corresponding to the target formula key is not found in the object reference pool, then a storage object corresponding to the target formula is created in the object reference pool, and the created storage object is reference as an instance attribute in the process of creating the formula instance.

In one implementation of the present disclosure, in the object reference pool, each of the storage objects corresponds to a reference counter, and the reference counter is for counting the number of references to a corresponding storage object.

In the embodiments of the present disclosure, reference counting capabilities are increased in the object reference pool, and when a formula instance is created and an instance attribute in the object reference pool is referenced, the number of references to the corresponding instance attribute in the object reference pool is counted. For example, a formula is added to the online table, and if the instance attribute corresponding to the formula is referenced once, the reference counter corresponding to the instance attribute is increased by 1. Likewise, after the formula is deleted from the online table, the reference counter corresponding to the instance attribute is decreased by 1.

In one implementation of the present disclosure, when the number of references to the storage object is 0, the storage object is deleted from the object reference pool.

In the embodiments of the present disclosure, when the number of references to the storage object is 0, it indicates that the corresponding formula does not exist in the online table. Therefore, the storage object is deleted from the object reference pool, so that this part of the memory occupation can be directly released so as to further reduce the memory occupation.

In one implementation of the present disclosure, the storage object is a formula symbol sequence attribute, and the formula symbol sequence attribute is for indicating a variable and/or a constant in a formula corresponding to the storage object.

In one implementation of the present disclosure, when two formulas in the online table have the same content except for the reference areas, the formula symbol sequences of the two formulas are the same, and hence the formula keys generated by the formula symbol sequences are also the same. However, corresponding intermediate compilation products IPs in the two formulas are different. In order to store the intermediate compilation product as part of the storage object in the reference pool for subsequent references, special processing needs to be performed on the intermediate compilation product IP.

In one implementation of the present disclosure, the method further comprises: generating a formula key based on a formula and a formula symbol sequence attribute corresponding to the formula; storing the formula symbol sequence attribute in the object reference pool, wherein the formula symbol sequence attribute is for indicating a variable and/or a constant in the formula.

In the embodiments of the present disclosure, when two formulas in the online table have the same content except for the reference areas, the formula symbol sequences of the two formulas are the same, and this part of content can be directly referenced.

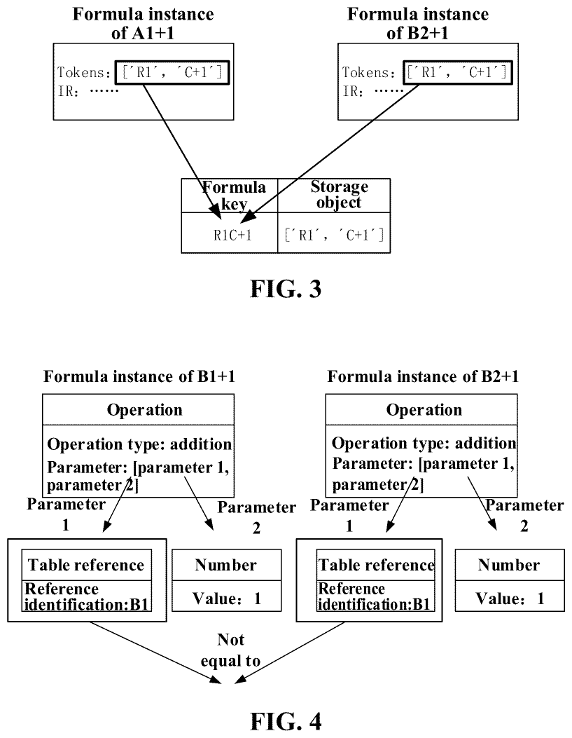

As shown in FIG. 3, in the formula instance of A1+1, the formula symbol sequence is tokens: [‘R1’, ‘C+1’], and in the formula instance of B2+1, the formula symbol sequence is tokens: [‘R1’, ‘C+1’], i.e., Symbols are the same for the two formulas. Hence, the corresponding storage object [‘R1’, ‘C+1’] may be directly referenced based on the formula key R1C+1, without the need of creating [‘R1’, ‘C+1’], so as to reduce the occupation of memory space.

In one implementation of the present disclosure, the method further comprises: generating, based on a formula, a formula parameter and a formula operation type corresponding to the formula; and storing the formula parameter and the formula operation type corresponding to the formula in the object reference pool, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

In the embodiments of the present disclosure, the formula operation type and the formula parameter may also be referred to as intermediate compilation products or formula compilation intermediate code for formula calculation. As shown in FIG. 4, the formula B1+1 corresponds to the formula operation type of addition, the formula parameters comprise a first parameter and a second parameter, the parameter type of the first parameter is a table reference, the reference area is B1, the parameter type of the first parameter is a number, and the specific number is 1.

In one implementation of the present disclosure, when other content is the same in the online table except for the reference area, IRs of two formula instances are different. As shown in FIG. 4, the reference area in the IR corresponding to the formula B1+1 is B1, and the reference area corresponding to the formula B2+1 is B2. Different IRs may be stored separately in the object reference pool, and while creating a formula instance, a corresponding IR may be referenced by referencing an area identification.

In one implementation of the present disclosure, the formula keys and formula symbol sequence attributes corresponding to the formulas B1+1 and B2+1 are all the same, so a formula symbol sequence attribute may be generated and stored in the object reference pool. When creating formula instances corresponding to B1+1 and B2+1, the corresponding formula symbol sequence attribute may be directly referenced through the formula key.

In one implementation of the present disclosure, the reference area in the IR corresponding to the formula B1+1 is B1, and the reference area corresponding to the formula B2+1 is B2. IR1 corresponding to B1+1 and IR2 corresponding to B2+1 may be generated respectively. IR1 is referenced when creating a formula instance corresponding to B1+1, and IR2 is referenced when creating a formula instance corresponding to B2+1. Further, the IR which the formula should reference may be determined based on both the formula key and the reference arca identification. For example, when creating a formula instance corresponding to the formula B1+1, the formula key is R1C+1, the reference arca identification is B1, and it may be determined based on the correspondence relationship between the formula key, the reference arca identification and the IR that the formula B1+1 references IR1. When creating a formula instance corresponding to the formula B2+1, the formula key is R1C+1, the reference area identification is B2, and it may be determined based on the correspondence relationship between the formula key, the reference arca identification and the IR that the formula B2+1 references IR2.

In one implementation of the present disclosure, when the parameter category of the first parameter is table reference, the value of the first parameter is set to a proxy reference, the value of the first parameter is stored as a reference tag, and the reference tag is for pointing to a cell identification referenced by a proxy.

When other content is the same in the online table except for the reference areas, the formula keys and formula symbol sequence attributes of two formulas are all the same, and their IRs are different. In order to make a formula key correspond to an IR so that it can be referenced when creating a formula instance, the table reference is specially processed as a proxy reference when generating IRs in the embodiments of the present disclosure.

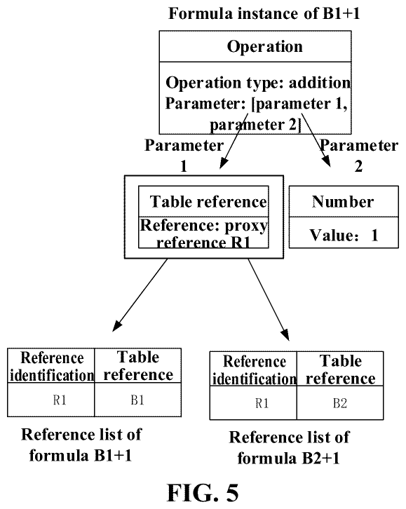

As shown in FIG. 5, the first parameter in the IR adopts a proxy reference. The reference tag is R1, and the proxy reference may be a reference list of the formula B1+1 and a reference list of the formula B2+1, respectively. In this way, an IR can describe a plurality of formulas with the same content except for different reference areas, and then such IRs are put into the reference pool, thereby improving the reuse rate and reducing the memory occupation.

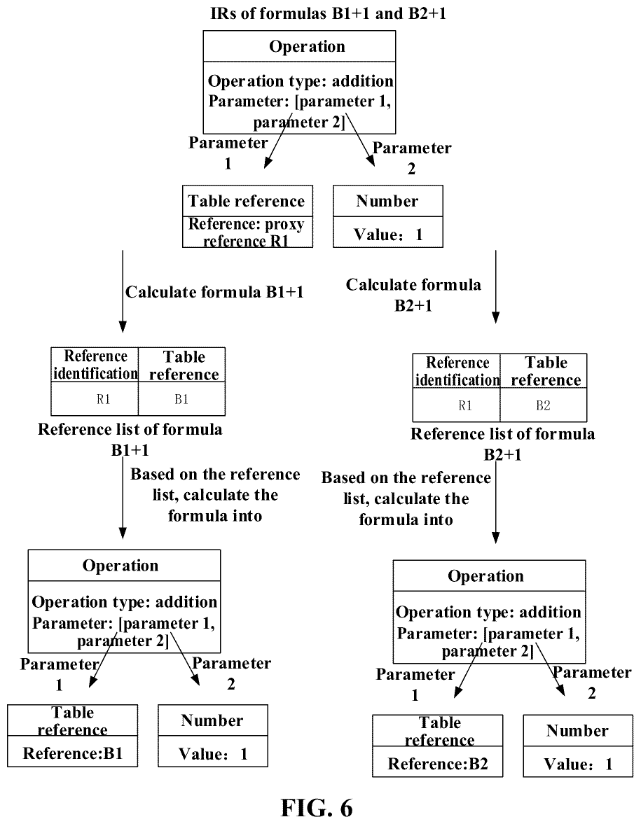

In the embodiments of the present disclosure, the proxy reference is converted to a real table reference of the formula instance during real formula calculation. As shown in FIG. 6, the formulas B1+1 and B2+1 correspond to the same IRs in the object reference pool, and when calculating the formula B1+1, the first parameter determines a reference list through a proxy reference, and the first parameter in the IR of the formula B1+1 is modified to referencing the cell B1 based on the reference list. When calculating the formula B2+1, the first parameter determines a reference list through a proxy reference, and the first parameter in the IR of the formula B2+1 is modified to referencing the cell B2 based on the reference list.

The embodiments of the present disclosure provide a table processing method, apparatus, device, storage medium and program product. The method comprises: in response to creating a target formula in an online table, determining a target formula key corresponding to the target formula; and creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula. Some instance attributes comprised in the formula instance created in the embodiments of the present disclosure reference storage objects, thereby reducing the occupation of the memory space.

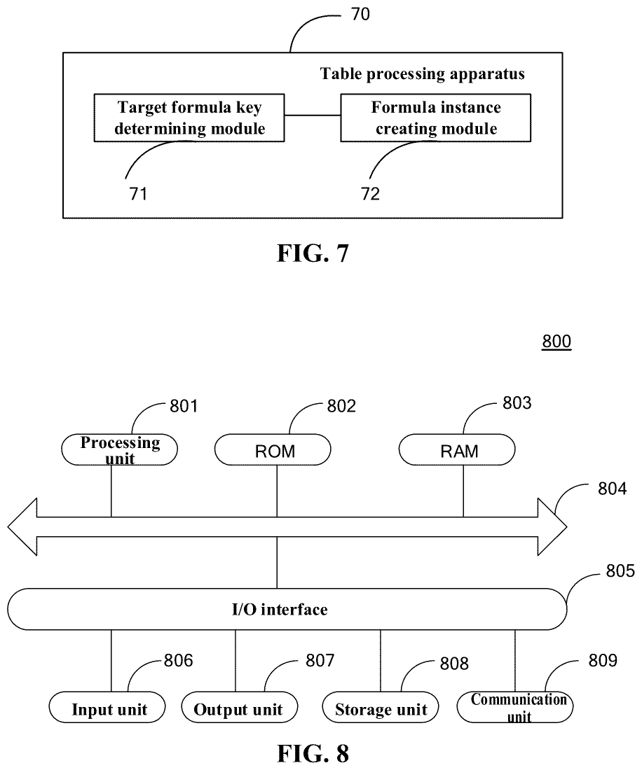

FIG. 7 is a structural schematic diagram of a table processing apparatus in the embodiments of the present disclosure. This embodiment is applicable to the optimization of formula instances in online tables. The table processing apparatus may be implemented in software and/or hardware and may be configured in the electronic device as described in FIG. 1.

As shown in FIG. 7, the table processing apparatus 70 provided by the embodiments of the present disclosure comprises: a target formula key determining module 71 and a formula instance creating module 72.

The target formula key determining module 71 is configured to, in response to creating a target formula in an online table, determine a target formula key corresponding to the target formula; and the formula instance creating module 72 is configured to create a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

In one implementation of the present disclosure, in the object reference pool, each of the storage objects corresponds to a reference counter, and the reference counter is for counting the number of references to a corresponding storage object thereof.

In one implementation of the present disclosure, in the event that the number of references to the storage object is 0, the storage object and the formula key corresponding to the storage object are deleted from the object reference pool.

In one implementation of the present disclosure, the apparatus further comprises: a formula symbol sequence attribute generating module configured to generate a formula key based on a formula and a formula symbol sequence attribute corresponding to the formula; and a formula symbol sequence attribute storage module configured to store the formula symbol sequence attribute in the object reference pool, wherein the formula symbol sequence attribute is for indicating a variable and/or a constant in the formula.

In one implementation of the present disclosure, the apparatus further comprises: a formula parameter generating module configured to generate, based on a formula, a formula parameter and a formula operation type corresponding to the formula; and a formula parameter storage module configured to store the formula parameter and the formula operation type corresponding to the formula in the object reference pool, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

In one implementation of the present disclosure, in the event that the parameter category of the first parameter is table reference, the value of the first parameter is set to a proxy reference, the value of the first parameter is stored as a reference tag, and the reference tag is for pointing to a cell identification referenced by a proxy.

The table processing apparatus provided by the embodiments of the present disclosure can perform the steps of the table processing method provided by the method embodiments of the present disclosure, with advantageous effects which are not repeated here.

FIG. 8 is a structural schematic diagram of an electronic device in the embodiments of the present disclosure. With reference to FIG. 8 below, this figure shows a structural schematic diagram of an electronic device 800 which is applicable to implement the embodiments of the present disclosure. The electronic device 800 in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device shown in FIG. 8 is merely an example and should not be construed as bringing any restriction on the functionality and usage scope of the embodiments of the present disclosure.

As shown in FIG. 8, the electronic device 800 may comprise a processing unit (e.g., a central processor, a graphics processor) 801 which is capable of performing various appropriate actions and processes to realize the table processing method as described in the embodiments of the present disclosure in accordance with programs stored in a read only memory (ROM) 802 or programs loaded from a storage unit 808 to a random access memory (RAM) 803. In the RAM 803, there are also stored various programs and data required by the electronic device 800 when operating. The processing unit 801, the ROM 802 and the RAM 803 are connected to one another via a bus 804. An input/output (I/O) interface 805 is also connected to the bus 804.

Usually, the following units may be connected to the I/O interface 805: an input unit 806 including a touch screen, a touch pad, a keyboard, a mouse, a camera, a microphone, an accelerometer, a gyroscope, or the like; an output unit 807, such as a liquid-crystal display (LCD), a loudspeaker, a vibrator, or the like; a storage unit 808, such as a magnetic tape, a hard disk or the like; and a communication unit 809. The communication unit 809 allows the electronic device to perform wireless or wired communication with other device so as to exchange data with other device. While FIG. 10 shows the electronic device with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 809, or installed from the storage unit 808, or installed from the ROM 802. The computer program, when executed by the processing unit 801, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs which, when executed by the electronic device, cause the electronic device to: in response to creating a target formula in an online table, determine a target formula key corresponding to the target formula; and create a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

In one possible implementation of the present disclosure, when the one or more programs are executed by the terminal device, the terminal device may further perform other steps as described in the above embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, cach block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an crasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, a table processing method is provided, comprising: in response to creating a target formula in an online table, determining a target formula key corresponding to the target formula; and creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

According to one or more embodiments of the present disclosure, a table processing method is provided, wherein in the object reference pool, each of the storage objects corresponds to a reference counter, and the reference counter is for counting the number of references to a corresponding storage object thereof.

According to one or more embodiments of the present disclosure, a table processing method is provided, wherein in the event that the number of references to the storage object is 0, the storage object and the formula key corresponding to the storage object are deleted from the object reference pool.

According to one or more embodiments of the present disclosure, a table processing method is provided, the method further comprising: generating a formula key based on a formula and a formula symbol sequence attribute corresponding to the formula; and storing the formula symbol sequence attribute in the object reference pool, wherein the formula symbol sequence attribute is for indicating a variable and/or a constant in the formula.

According to one or more embodiments of the present disclosure, a table processing method is provided, the method further comprising: generating, based on a formula, a formula parameter and a formula operation type corresponding to the formula; and storing the formula parameter and the formula operation type corresponding to the formula in the object reference pool, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

According to one or more embodiments of the present disclosure, a table processing method is provided, wherein in the event that the parameter category of the first parameter is table reference, the value of the first parameter is set to a proxy reference, the value of the first parameter is stored as a reference tag, and the reference tag is for pointing to a cell identification referenced by a proxy.

According to one or more embodiments of the present disclosure, a table processing apparatus is provided, comprising: a target formula key determining module configured to, in response to create a target formula in an online table, determining a target formula key corresponding to the target formula; and a formula instance creating module configured to create a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

According to one or more embodiments of the present disclosure, atable processing apparatus is provided, wherein in the object reference pool, each of the storage objects corresponds to a reference counter, and the reference counter is for counting the number of references to a corresponding storage object thereof.

According to one or more embodiments of the present disclosure, a table processing apparatus is provided, wherein in the event that the number of references to the storage object is 0, the storage object and the formula key corresponding to the storage object are deleted from the object reference pool.

According to one or more embodiments of the present disclosure, a table processing apparatus is provided, the apparatus further comprising: a formula symbol sequence attribute generating module configured to generate a formula key based on a formula and a formula symbol sequence attribute corresponding to the formula; and storing the formula symbol sequence attribute in the object reference pool, wherein the formula symbol sequence attribute is for indicating a variable and/or a constant in the formula.

According to one or more embodiments of the present disclosure, a table processing apparatus is provided, the apparatus further comprising: a formula parameter generating module configured to generate, based on a formula, a formula parameter and a formula operation type corresponding to the formula; and a formula parameter storage module configured to store the formula parameter and the formula operation type corresponding to the formula in the object reference pool, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

According to one or more embodiments of the present disclosure, a able processing apparatus is provided, wherein in the event that the parameter category of the first parameter is table reference, the value of the first parameter is set to a proxy reference, the value of the first parameter is stored as a reference tag, and the reference tag is for pointing to a cell identification referenced by a proxy.

According to one or more embodiments of the present disclosure, an electronic device is provided, comprising:

one or more processors;

a storage unit configured to store one or more programs,

the one or more programs, when executed by the one or more processors, causing the one or more processors to implement the table processing method as described in the first aspect.

According to one or more embodiments of the present disclosure, a computer readable storage medium is provided, storing a computer program thereon, wherein the computer program, when executed by a processor, implements the table processing method as described in the first aspect.

According to one or more embodiments of the present disclosure, a computer program product is provided, comprising a computer program or instructions which, when executed by a processor, implement the table processing method as described in the first aspect.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

I/we claim:

1. A formula processing method, comprising:
in response to creating a target formula in an online table, determining a target formula key corresponding to the target formula; and
creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

2. The formula processing method of claim 1, wherein in the object reference pool, each of the storage objects corresponds to a reference counter, and the reference counter is for counting a number of references to a storage object corresponding thereto.

3. The formula processing method of claim 2, wherein in the event that the number of references to the storage object is 0, deleting the storage object and the formula key corresponding to the storage object from the object reference pool.

4. The formula processing method of claim 1, further comprising:
generating, based on a formula, a formula key and a formula symbol sequence attribute corresponding to the formula; and
storing the formula symbol sequence attribute in the object reference pool, wherein the formula symbol sequence attribute is for indicating a variable and/or a constant in the formula.

5. The formula processing method of claim 1, further comprising:
generating, based on a formula, a formula parameter and a formula operation type corresponding to the formula; and
storing the formula parameter and the formula operation type corresponding to the formula in the object reference pool, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

6. The formula processing method of claim 1, wherein in the event that the parameter category of the first parameter is table reference, the value of the first parameter is set to a proxy reference, the value of the first parameter is stored as a reference tag, and the reference tag is for pointing to a cell identification referenced by a proxy.

7. An electronic device, comprising:
one or more processors;
a storage unit configured to store one or more programs,
the one or more programs, when executed by the one or more processors, causing the one or more processors to implement a method comprising:
in response to creating a target formula in an online table, determining a target formula key corresponding to the target formula; and
creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

8. The electronic device of claim 7, wherein in the object reference pool, each of the storage objects corresponds to a reference counter, and the reference counter is for counting a number of references to a storage object corresponding thereto.

9. The electronic device of claim 8, wherein in the event that the number of references to the storage object is 0, deleting the storage object and the formula key corresponding to the storage object from the object reference pool.

10. The electronic device of claim 7, wherein the method further comprises:
generating, based on a formula, a formula key and a formula symbol sequence attribute corresponding to the formula; and
storing the formula symbol sequence attribute in the object reference pool, wherein the formula symbol sequence attribute is for indicating a variable and/or a constant in the formula.

11. The electronic device of claim 7, wherein the method further comprises:
generating, based on a formula, a formula parameter and a formula operation type corresponding to the formula; and
storing the formula parameter and the formula operation type corresponding to the formula in the object reference pool.

12. The electronic device of claim 11, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

13. The electronic device of claim 7, wherein in the event that the parameter category of the first parameter is table reference, the value of the first parameter is set to a proxy reference, the value of the first parameter is stored as a reference tag, and the reference tag is for pointing to a cell identification referenced by a proxy.

14. A computer program product comprising a computer program or instructions which, when executed by a processor, implement a method comprising:
in response to creating a target formula in an online table, determining a target formula key corresponding to the target formula; and
creating a formula instance based on the target formula key, wherein a target instance attribute comprised in the formula instance references a target storage object in a pre-created object reference pool, the object reference pool comprises correspondence relationships between formula keys and storage objects, the target storage object is a storage object having a correspondence with the target formula key, and the formula instance is for calculating the target formula.

15. The computer program product of claim 14, wherein in the object reference pool, each of the storage objects corresponds to a reference counter, and the reference counter is for counting a number of references to a storage object corresponding thereto.

16. The computer program product of claim 14, wherein in the event that the number of references to the storage object is 0, deleting the storage object and the formula key corresponding to the storage object from the object reference pool.

17. The computer program product of claim 14, wherein the method further comprises:
generating, based on a formula, a formula key and a formula symbol sequence attribute corresponding to the formula; and
storing the formula symbol sequence attribute in the object reference pool, wherein the formula symbol sequence attribute is for indicating a variable and/or a constant in the formula.

18. The computer program product of claim 14, wherein the method further comprises:
generating, based on a formula, a formula parameter and a formula operation type corresponding to the formula; and
storing the formula parameter and the formula operation type corresponding to the formula in the object reference pool.

19. The computer program product of claim 18, wherein the formula parameter comprises a first parameter and/or a second parameter, a parameter category of the first parameter is table reference, a value of the first parameter is a cell identification, and the cell identification is for indicating that a numeric value corresponding to the first parameter in the formula corresponding to the storage object is a numeric value in a cell corresponding to the cell identification; a parameter category of the second parameter is number, and a value of the second parameter is a numeric value at a corresponding position in the target formula.

20. The computer program product of claim 14, wherein in the event that the parameter category of the first parameter is table reference, the value of the first parameter is set to a proxy reference, the value of the first parameter is stored as a reference tag, and the reference tag is for pointing to a cell identification referenced by a proxy.
